(19) United States
(12) Patent Application Publication
(10) Pub. No.: US 2011/0272601 A1
(43) Pub. Date: Nov. 10, 2011

(54) RAPID TEST FOR DETERMINING THE EFFECT IRRADIATION HAS ON THE ABRASION OF A GRANULATE

(75) Inventors: Marisa Cruz, Grokrotzenburg (DE); Rainer Fuchs, Moembris (DE); Frank Dieter Kuhn, Gelnhausen (DE)

(73) Assignee: EVONIK DEGUSSA GmbH, ESSEN (DE)

(21) Appl. No.: 13/144,418

(22) PCT Filed: Dec. 29, 2009
(86) PCT No.: PCT/EP09/67981

§ 371 Date: Jul. 13, 2011

(30) Foreign Application Priority Data
Jan. 13, 2009 (DE) 10-2009-000179.4

(51) Int. Cl. G21K 5/00

(52) U.S. Cl. 250/492.1

(57) ABSTRACT

Rapid test to ascertain the effect of irradiation on the abrasion of a granule, in which
i.) the abrasion of the granule is determined before the irradiation,
ii.) the granule is irradiated,
iii.) the abrasion of the irradiated granule is determined,
   characterized in that,
   the abrasion is determined by
a) grinding the granule in a cutting mill,
b) subjecting the ground product to a screening analysis and
c) comparing the result of the screening analysis with at least one reference value, in order to classify the abrasion of the granule,
   the granule is irradiated by arranging a plurality of granule particles in a sample container (2) and irradiating them with an irradiation lamp (3), the granule particles being periodically blended during the irradiation so that different surfaces of the granule particles are irradiated.

### FIELD OF THE INVENTION

The present invention relates to a rapid test for ascertaining the effect of irradiation on the abrasion of a granule, preferably an inorganic or organic granule, particularly preferably a plastic granule.

### PRIOR ART

Plastic granules are a typical form in which thermoplastics are delivered by the raw material producer for the plastics processing industry. Owing to their flowability they are a bulk material, like sand or gravel, and therefore comparatively easy to transport and process further.

Recently, the use of plastic granules as a filler for artificial turf has been discussed intensively. For example, European Patent Application EP 1 416 009 A1 discloses the use of coated rubber particles as litter material or as a loose elastic layer for synthetic turf or other surfacings. The rubber particles are generally shaped irregularly, with n vertices, and preferably have an average size of between 0.4 mm and 2.5 mm up to at most 4.0 mm. The individual rubber particles are provided with a 5 μm to 35 μm thick covering over their entire surface. The covering forms a permanent elastic coating which is intended to substantially prevent the leaching of pollutants, for example zinc. This encapsulation is furthermore intended to reduce a rubbery smell typical of old rubber.

For use as a filler material for synthetic turf, such plastic granules must inter alia have a high abrasion strength. To date, however, there is no known test by which the abrasion strength of plastic granules can be ascertained and assessed rapidly and economically in a straightforward way.

Previously, the so-called Hardgroove test according to ISO 5074 has been carried out in order to test the abrasion strength of synthetic turf granules (infill material). To this end, the plastic granule is ground in a special ball mill (500 revolutions), without any pulverizing or other modifications of the rubber granule being permitted. The particle sizes of the plastic granule before and after grinding are ascertained and compared with one another, an abrasion strength of at least 95% being required in order to pass the test.

This test, however, has many disadvantages:
It generates relatively little abrasion (requisite abrasion stability 95% for correct conduct of the test with suitable filler materials). Although this is advantageous for approving as many synthetic turf particle systems as possible, it is not useful for being able to determine the suitability of different materials and compare them meaningfully with one another in a rapid and simple way. For example, different coatings which have a different abrasion behaviour cannot be distinguished from one another by this method, or can be distinguished only slightly, because the measurement results obtained lie very close together. For example, it is therefore not possible to rank different abrasion-proof coatings relative to one another. At best, such ranking is achieved only in a narrow framework which differs little or not at all from the usual variation range of the measurement values obtained. When filler materials are ranked with this test by ISA, all products with an abrasion stability ≧95% are classified as suitable for use as synthetic turf filler materials according to the Dutch standard for rubber-based infill materials, ISA-M37.
Furthermore, the required ball mill is comparatively expensive.
The test is extremely time-consuming since 500 revolutions are required, and very laborious, the test apparatus can scarcely be transported for example owing to the weight of the equipment, and maximally quantitative emptying of the apparatus is extremely time-consuming and difficult because many particles adhere to the large surface, for example by electrostatic charging effects of the particles or the test apparatus surface.
The method requires a very large amount of sample material.
It is difficult to thermally regulate the mill, in order to be able to measure the abrasion behaviour at different temperatures.

Occasionally, other abrasion test methods are also used for filler granules, for example using a roller block or ring shear cell. These methods also exhibit substantial disadvantages. It takes a very long time to generate perceptible or measurable abrasion by means of a roller block. Furthermore, it is very difficult or even impossible to quantitatively transfer the fine fraction generated, owing to the large surface area and possibly high electrostatic charging. The equipment is hard to fill and empty, and difficult to thermally regulate in order to be able to measure the abrasion behaviour at different temperatures.

It also takes a very long time to generate perceptible or measurable abrasion by means of a ring shear cell. Quantitative transfer of the material from the apparatus after grinding is difficult, and it is likewise difficult to clean the apparatus. Furthermore, the apparatus can only be thermally regulated with difficulty in order to be able to measure the abrasion behaviour at different temperatures.

The abrasion determination methods (DIN 53516) for plastic blocks and sheets (and therefore for example for coloured material such as EPDM or TPE) are described in DIN V18035-7:2002-06, but cannot be used for abrasion methods on coated used tyre rubber granule.

The same applies to the abrasion test described in DIN ISO 4649 for cylindrical elastomer specimens which are exposed to a defined abrasion stress by means of an emery sheet. This test likewise cannot be used for small-piece granules.

For use as a filler material for synthetic turf, it is furthermore important to find out how the properties of such plastic granules, in particular the abrasion, change under solar irradiation over time (so-called ageing of the plastic granules). To date, however, there is no known test by which the solar irradiation of plastic granules can be simulated and assessed rapidly and economically in a straightforward way, and which makes it possible to determine the effect of irradiation on the plastic granules, in particular on the particle surfaces, within a short time.

Only various treatment methods for the irradiation of the surfaces of coated or uncoated sheets or other two-dimensional surfaces or coated or uncoated particles are known. For example the test, which may furthermore be used for particulate systems, is used to test the effect of UV rays on motor vehicle paint. This employs a container, in which the coated or uncoated particles to be exposed are scattered and then exposed.

As another example of the irradiation of coated or uncoated particles, equipment which operates according to the standard ISO 4892-3 is used by the ISA Sport institute to evaluate the weathering resistance of filler materials for synthetic turf. Here, a coated or uncoated rubber granule is subjected to a climatic simulation in which the sample is exposed to UV light for a period of 125 days.

These tests, however, have various disadvantages which are an obstacle to rapidly estimating the effect of solar irradiation on the properties of plastic granules:
The tests are laborious and extremely time-consuming, because they generally require irradiation over several months or years.
There is currently no test which allows coated or uncoated particles, for example plastic granule, to be exposed uniformly over the entire surface to light and weathering. This, however, is necessary in order to achieve a maximally uniform behaviour of the entire coated or uncoated particles over their entire surface. Because only one side of the coated or uncoated granules is exposed, two very different surfaces are obtained so that various further analyses and determinations (for example pollutant elution, colour measurement) on the exposed coated or uncoated granules are possible only with difficulty.
Some of the previous tests can only treat a small amount of material at a time; in order to carry out the analysis methods following the irradiation (for example colour measurement, pollutant elution), however, it is important for sufficient specimen material to be available.
Sometimes, surfaces must be irradiated while suspended (for example in the xenon test). With granules, this can only be done if they are bonded to a surface which is then irradiated while suspended. In this case, it is extremely hard to release the particles and the adhesive remaining on the particles vitiates the results of subsequent studies. Furthermore, only one particles side is likewise irradiated.

Furthermore, it is important to find out how the colour, the zinc elution and the water retention capacity of such plastic granules change under irradiation. For instance, ascertaining the water retention capacity provides a very good indicator of the suitability of a material as a synthetic turf filler material: the faster the water drains, the sooner the material can be played on again. Particularly in spring and autumn, this parameter is very important because whenever water remains in the bed for a long time, it can freeze and make the pitch no longer playable. Moreover, excessively moist plastic granule is slippery and/or treacherous.

If however it is desirable for water to remain in the bed after watering (for example for cooling, or reducing friction when footballers slide or fall in summer), then filler materials which have a medium to high water retention capacity are preferable.

### SUMMARY OF THE INVENTION

It was therefore an object of the present invention to provide ways of rapidly testing the effect of irradiation on the abrasion strength of granules, in particular filler materials for synthetic turf.

Furthermore, a rapid test was desired to ascertain the effect of irradiation on the strength and the bonding of material layers on surfaces or interlayers of multilayered granules.

The test should be as rapid and effective as possible to carry out, as widely usable as possible and allow maximally accurate classification of the abrasion behaviour of various granules. In particular, it should be suitable for testing coated rubber particles.

The rapid test should if possible furthermore satisfy the following criteria:
Maximally economical determination of the abrasion behaviour and optionally other properties.
Maximally rapid determination of the abrasion behaviour and optionally other properties.
Maximally simple operation.
Maximally universal use; any required test apparatus should be as easy as possible to transport and occupy the least possible space.
The smallest possible required amount of specimen.
Very sensitive test, which allows maximally accurate assessment and classification of the abrasion behaviour of very different materials, and in particular
   still make it possible to distinguish the abrasion behaviours of very similar but not identical coatings.
   make it possible to distinguish between uniformly coated rubber particles or uncoated rubber particles but with different weathering or pretreatment of the product.
   make it possible to distinguish between uniformly coated organic or inorganic bodies or polymers or uncoated organic or inorganic bodies or polymers after different weathering or pretreatment.
If possible not only the measurement of one point, i.e. the abrasion behaviour at a particular time, but also the measurement of a profile of the abrasion behaviour over time, in order to be able to determine the abrasion behaviour of granules, in particular coatings, coating/rubber interfaces, rubber surfaces and/or deep rubber layers after irradiation.
If possible both the measurement of a defined point (for rapid comparison purposes) and the measurement of different points on a curve (abrasion as a function of time), particularly in order to obtain information about the coating, the binding of the coating to the rubber surface or the rubber bulk material, the pigment binding in the coating and/or the coating thickness or layer thickness distribution of the coating.
Usability at as many different temperatures as possible, in particular at elevated temperatures, in order to simulate the behaviour of synthetic turf filler materials in the top filler material layer in summer, and/or at low temperatures in order to simulate the behaviour of synthetic turf filler materials in the cold season (autumn, winter).
If possible, indication of the completeness of the curing of the polymer coating in the case of coated granules.

It was also an object of the invention to provide ways for improved simulation of the effect of solar rays on the properties of granules, in particular filler materials for synthetic turf.

When developing coatings of particles, it would be highly advantageous to obtain results as rapidly as possible which can be used in order to test different coatings for their stability in relation to UV irradiation and select the superior coatings.

It would more particularly be advantageous if the UV radiation which strikes the Earth could be used, i.e. in general UV-B and UV-A radiation with a wavelength >295 nm. It would furthermore be more particularly advantageous if primarily UV-B radiation could be used for the testing, since a great deal of damage to coatings results from exposure to UV-B radiation.

The intention was also to find a way of achieving a maximally uniform effect over the entire surface of the granules.

In particular, a solution was desired which
allows rapid simulation of the effect of solar rays on the properties of granules,
is easy to carry out and operate,
can be implemented as economically as possible,
is usable as widely as possible,
requires the smallest possible minimum amounts of specimen but can nevertheless provide sufficient specimen amounts of exposed granule for subsequent studies,
but optionally also allows the treatment of large quantities of specimen,
is as selective as possible, so that it is also possible to distinguish between the ageing behaviours of very different granules,
allows not only the measurement of one point, but also the measurement of a profile of the ageing over time; in this way, further important information about the ageing behaviour of coatings, particles and in particular used tyre rubber granule can be obtained. Furthermore, the effect of the type and amount of pigmentation containing the granules on the ageing could also be ascertained in this way.

These and other objects, which may be taken from the contexts discussed, are achieved by providing a rapid test having all the features of patent claim 1. Particularly expedient variants of the rapid test are described in the related dependent claims. The protection also includes a granule which has an outstanding property profile and is therefore suitable in particular as a filler material for synthetic turf.

By carrying out a test in which
i.) the abrasion of the granule is determined before the irradiation,
ii.) the granule is irradiated,
iii.) the abrasion of the irradiated granule is determined,
   wherein,
the abrasion being determined by
   a) grinding the granule in a cutting mill,
   b) subjecting the ground product to a screening analysis and
   c) comparing the result of the screening analysis with at least one reference value, in order to classify the abrasion of the granule,
the granule is irradiated by arranging a plurality of granule particles in a sample container (2) and irradiating them with an irradiation lamp (3), the granule particles being periodically blended during the irradiation so that different surfaces of the granule particles are irradiated,
   the effect of solar rays on the abrasion behaviour of granules, in particular filler materials for synthetic turf, can be simulated better in a way which was not readily predictable.

Furthermore, the procedure according to the invention offers many other advantages:
The method according to the invention makes it possible to study both coated and uncoated particles, and coated or uncoated particle mixtures.
The method according to the invention is extremely rapid and very easy to carry out, and requires only a very small workforce and short time. In particular, it allows information to be obtained about possibly existing long-term UV damage due to solar exposure of the irradiated coated or uncoated product by using a high radiation dose during a short exposure time.
The method according to the invention is very economical.
With respect to the sample quantity studied, the method according to the invention is very flexible. Both very large amounts and very small amounts of aged granules can be obtained, depending on how much sample material is required for the subsequent studies.
A test is possible without previously fixing the granules.
In the method according to the invention, the entire surface of the granules is exposed uniformly, which leads to much easier determination of the properties of the aged granules.
By using the method according to the invention, it is also possible to study granules with a complex structure, which are for example nonuniformly coated and/or have an angular or other more complex, possibly irregular or spherical shape.
The test according to the invention makes it possible to obtain information about the effect of the irradiation on the strength and bonding of material layers on surfaces or in interlayers of multilayered granules.
The test according to the invention allows very accurate classification of the abrasion behaviour of different granules. It is suitable in particular for testing coated rubber particles, which are used as filler materials for synthetic turf.
The test according to the invention is very sensitive, allows extremely accurate assessment and classification of the abrasion behaviour of very different materials and, in particular,
   it still makes it possible to distinguish between the abrasion behaviours of similar but not identical coatings.
   it makes it possible to distinguish between uniformly coated rubber particles or uncoated rubber particles but with different weathering or pretreatment of the product.
   it makes it possible to distinguish between uniformly coated organic or inorganic bodies or polymers or uncoated organic or inorganic bodies or polymers after different weathering or pretreatment.
It is possible to ascertain the abrasion behaviour at different temperatures, in particular at elevated temperatures, in order to simulate the behaviour of synthetic turf filler materials in the top filler material layer in summer, and/or at low temperatures in order to simulate the behaviour of synthetic turf filler materials in the cold season (autumn, winter).
By observing colorations or deposits on the mill wall caused by the abrasion test, information can be obtained about the completeness of the curing of polymer layers or layer systems. This is particularly important for the development of new material or paint for coating systems, adhesive systems or composite systems or bulk material or pellets made of one or more materials.

### FIGURE

FIG. 1 shows a preferred embodiment of a device for the irradiation of granules.

### LIST OF REFERENCES

| | |
|---|---|
| 1 | temperature control element |
| 2 | sample container |
| 3 | irradiation lamp |
| 4 | inert gas flushing |
| 5 | quenching space |
| 7 | canted ends |

### DETAILED DESCRIPTION OF THE INVENTION

The test according to the invention is used to rapidly determine the effect of light on the abrasion strength of granules, expediently inorganic or organic granules, preferably plastic granules, particularly preferably coated plastic granules, in particular coated rubber particles which are used inter alia as litter material or as a loose elastic layer for synthetic turf or other surfacings.

The rubber particles are generally shaped irregularly, with n vertices, and preferably have an average size of between 0.4 mm and 4.0 mm. The maximum grain size of the particles is preferably less than 10 mm, particularly preferably less than 7 mm. The minimum grain size of the particles is preferably greater than 0.1 mm, particularly preferably greater than 0.5 mm. The individual rubber particles are preferably provided with a 5 μm to 35 μm thick covering over their entire surface. The covering forms a permanent elastic coating which is intended to substantially prevent the leaching of pollutants, for example zinc. This encapsulation is furthermore intended to reduce a rubbery smell typical of old rubber. Further details of such plastic granules may be found, for example, in European Patent Application EP 1 416 009 A1.

The test according to the invention is capable in particular of distinguishing well between different coatings. For instance, the quality of coloured coatings may be evaluated by stronger or weaker coloration of the wall of the cutting mill after carrying out the abrasion test. The degree of coloration of the mill wall may, for example, be determined by visual comparison with various reference colorations. As an alternative, other suitable methods may also be used to determine adhesions on the mill wall, in order to establish the extent to which curing of layers has progressed, which is advantageous in particular for colourless coating systems.

Furthermore, the test according to the invention may also be used in order to evaluate the binding of a material composite. To this end particles which have been obtained from the material composite, and have preferably been cut, stamped or broken from the material composite, are preferably studied.

The rapid test according to the invention comprises the steps of
i.) determining the abrasion of the granule before the irradiation,
ii.) irradiating the granule,
iii.) determining the abrasion of the irradiated granule.

The determination of the abrasion strength includes the following steps:

### A) Grinding in a Cutting Mill

First, an attempt is made to comminute the granule at least partially by grinding. To this end, in the scope of the present invention, a cutting mill is used which conventionally consists of a horizontally or vertically arranged rotor that is equipped with blades, which in the scope of a first particularly preferred embodiment of the present invention work against blades anchored in the housing of the mill. A schematic diagram of such a mill is given in Römpp Lexikon Chemie, editors: J. Falbe, M. Regitz, 10^{th} edition, Georg Thieme Verlage, Stuttgart, N.Y., 1998, volume: 4, keyword: “Mühle”, page 2770. For further details, reference is therefore made to this publication and the cited literature references.

In the scope of a second particularly preferred embodiment of the present invention, the housing of the mill does not comprise anchored blades, so that the ground granule can be removed more easily from the housing.

The working principle of the cutting mill is preferably cutting/impact.

The intensity of the grinding can be controlled via the energy exerted by the mill. In the scope of the present invention, it is preferable to use cutting mills which exert a cutting mill energy in the range of from 10 W to 400 W, particularly in the range of from 50 W to 300 W.

The rotation speed of the cutting mill preferably lies in the range of from 100/min to 30,000/min, particularly in the range of from 1000/min to 25,000/min.

The circumferential speed of the cutting mill preferably lies in the range of from 10 m/s to 100 m/s, particularly in the range of from 20 m/s to 80 m/s.

The dimensioning of the mill may in principle be selected freely and adapted to the requirements of the particular case. Expediently, the grinding chamber of the cutting mill is filled to at least 10% during the grinding, expressed in terms of the maximum working volume of the cutting mill.

The cutting mill and the cutting tool are preferably made of a material which is harder than the granule to be studied. It has proven particularly suitable to use grinding chambers and cutting blades made of stainless steel, in particular stainless steel 1.4034.

In the scope of the present invention, the material to be ground is preferably placed in the chamber of the cutting mill and sheared by a stainless steel beater for a predetermined stressing time (“grinding time”). This gives rise to mutual friction, impact and cutting of granules or layers on the granules. Owing to the large-scale and complex nature of the shearing, a rapid test is achieved for the abrasion stability of granules, in particular coated plastic granules. The results of the test are affected above all by the following variables:
Elasticity of the coating.
Shear strength of the coating.
Bonding strength of the coating on the particle.
Size of the particles.
Size distribution of the particles.
Elasticity of the particles.
Shear strength of the particles.

The results are also affected by the duration of the grinding. For the purposes of the present invention, it is preferable to select grinding times in the range of from 5 seconds to 10 minutes, particularly in the range of from 5 seconds to 150 seconds.

The grinding force of the cutting mill may act continuously or discontinuously. A procedure in which the grinding force is preferably not varied during the grinding has proven suitable.

If need be, the grinding chamber of the cutting mill may be thermally regulated during the grinding, in particular heated or cooled, in order to obtain information about the abrasion behaviour of the granules at different temperatures. Thermal regulation which changes in the course of the grinding may also be envisaged. To this end a suitable thermally regulated liquid, for example water, is preferably introduced into the heating/cooling chamber of the grinding chamber.

Grinding mills suitable for the purposes of the present invention are commercially available. The following mill has proven more particularly suitable:
analysis mill: Universal Mill M20,
   manufacturer: IKA-Werke GmbH & Co. KG
   working principle: cutting/impact
   max. rotation speed (1/min.): 20,000
   beater/blade material: stainless steel 1.4034
   grinding chamber material: stainless steel 1.4301

### B) Screening the Sheared Granules

After grinding, the particle size distribution of the ground product is ascertained by screening analysis, a procedure in accordance with DIN 53 477 (November 1992) preferably being adopted.

It is preferable to use round analysis screens (referred to as screens for short) whose screening frame preferably consists of metal. The screens preferably have a rated diameter of 200 mm. The screening cover, including the screening frame and the screening pan, preferably fit onto or into one another so as to create a seal. Metal wire fabric according to DIN ISO 3310 Part 1 is preferably stretched over the screens. In many cases, a screening set of 6 screens with metal wire fabric (mesh width: 63 μm, 125 μm, 250 μm, 500 μm, 1 mm, 2 mm) is sufficient. For the purposes of the present invention, it is particularly preferable to use a screening set which comprises a 500 μm screen and a bottom.

Mechanical screening aids, such as rubber cubes, are not recommendable owing to the risk of vitiating the results and damaging the screen having metal wire fabric.

Selection of the plane screening machine is preferably used to ensure that separation into grain fractions, corresponding to the screened material, is completed after 15 minutes. The separation is preferably achieved by a horizontal circular movement of the screening set with a rotation frequency of preferably 300+−30 min⁻¹ and an amplitude of 15 mm.

The screening is preferably carried out discontinuously, particularly preferably in a plurality of intervals, more particularly preferably in from 3 to 10 intervals, particularly in 5 intervals. The intervals are preferably of equal length and expediently last from 1 minute to 5 minutes, in particular 3 minutes. After each interval, the screening is preferably interrupted and then restarted again. This may optionally be programmed on the screening machine.

Screening machines suitable for the purposes of the present invention are commercially available. The following screening machine has proven more particularly suitable:
screening machine: model: AS 400 Control
   manufacturer: Retsch GmbH
   screened material movement: horizontal circular
   rotation speed digital: 50-300 min⁻¹
   interval operation 1-10 min
   E×H×D: 540×260×507 mm

### B) Weighing the Different Screening Fractions

The particle size distribution is ascertained in a manner known per se by weighing out the screen.

The result of the screening analysis is compared with at least one reference value, in order to classify the abrasion of the granule.

In this case, the ascertained particle size distribution of the ground product is preferably compared with the result of at least one other granule, in order to classify the abrasion of the granules in comparison with the other granule.

In the scope of another preferred embodiment of the present invention, the ascertained particle size distribution of the ground product is compared with the particle size distribution of the underground educt, in order to categorize the abrasion of the granule being studied.

In the scope of a third preferred embodiment of the present invention, the ascertained particle size distribution of the ground product is compared with at least one predetermined threshold value, in order to categorize the abrasion of the granule being studied.

Moreover, for the purposes of the present invention the fraction of particles smaller than 500 μm has in particular proven to be a particularly suitable criterion for evaluating the abrasion of the particles.

### D) Optional: Checking Deposits on the Walls of the Grinding Chamber

In the scope of a particularly preferred variant of the present invention, the walls are checked after the grinding for possible deposits which have been caused by the shearing of the granule in the cutting mill. By optional comparison (for example with suitable reference samples, references, reference scales), it is generally possible to assess or rank the strength and the bonding of material layers on surfaces or in interlayers of multilayer granules.

For the inventive irradiation of the granules, the granules are arranged in a sample container and irradiated with an irradiation lamp, the granules being blended periodically during the irradiation so that different surfaces of the granules are irradiated.

The term “periodically” in this context refers to an action (here blending) recurring regularly at equal intervals, repetition of at least 2 processes, preferably at least 5 processes, in particular at least 10 processes being preferred here.

The repetition rate of the action (here blending) is preferably at least 1 process per minute, preferably at least 5 processes per minute, in particular at least 10 processes per minute. In the scope of a particularly preferred embodiment of the present invention, continuous blending is carried out during the irradiation.

The term “blending” in the scope of the present invention refers to thorough mixing of the granules. This preferably leads to a change in the three-dimensional orientation of at least two granules, preferably at least 5 granules, in particular at least 10 granules. Furthermore the mutual relative positions of at least two granules, preferably at least 5 granules, in particular at least 10 granules, are preferably changed.

In the scope of a particularly preferred embodiment of the present invention, the granules are blended so that at least two different surfaces, preferably at least three different surfaces of the granules are irradiated successively, each of these surfaces being irradiated at least twice, preferably at least five times, in particular at least 10 times.

Owing to the periodic blending of the granules, the irradiation method according to the invention differs from the known irradiation methods in which the granules are not blended during the irradiation and only one surface of the granules is irradiated continuously.

The method according to the invention leads to very uniform irradiation of the entire surface of the granules. The irradiation is preferably carried out in such a way that the difference between the shortest irradiation time of a surface of the granules and the longest irradiation time of a surface of the granules is at most 100%, preferably at most 50%, in particular at most 20% of the longest irradiation time of a surface of the granules.

The irradiation simulates the effect of light, in particular sunlight, on the granules. The light therefore preferably comprises components of natural sunlight; the irradiation is preferably carried out with a wavelength in the range of from 1 nm to 1000 nm, preferably with a wavelength in the range of from 200 nm to 400 nm (so-called near UV radiation), in particular with a wavelength in the range of from 295 nm to 350 nm (so-called UV-B radiation).

For the purposes of the present invention, it is particularly advantageous to use a device according to the invention for irradiating granules. This device comprises
a. at least one irradiation lamp and
b. at least one sample container for the granule to be irradiated,
   the sample container being connected to a drive so that the sample container can be moved during the irradiation and the granules can be blended.

The position of the irradiation lamp relative to the sample container may in principle be selected freely, the irradiation lamp preferably being arranged inside the sample container. It may however also be arranged outside the sample container, although this variant is less preferred.

Direct action of the rays on the granule to be irradiated is furthermore preferred. Materials which can partially or fully absorb or deviate the light from the irradiation source are therefore to be avoided if possible on the line of sight between the irradiation lamp and the granule. This is unless undesired radiation, for example IR radiation (heat radiation) is intended to be reduced by special materials, for example filters, together with the best possible transparency for UV-B radiation.

The irradiation lamp is preferably surrounded by inert gas flushing, which is preferably arranged between the irradiation lamp and the sample container. Inert gases which are particularly suitable for the purposes of the present invention comprise in particular nitrogen and all noble gases, such as helium and neon.

In the scope of a particularly preferred embodiment of the present invention, the granules in the sample space are furthermore flushed with at least one gas and/or at least one liquid in order to study the effect of the gas and/or the liquids on the properties of the granule during the irradiation. Air, water vapour, acidic water vapour, acid rain and water are particularly suitable for these purposes.

The irradiation lamp is furthermore preferably provided with a filter, which filters out IR radiation (780 nm to 1 mm) at least partially from the radiation spectrum of the irradiation lamp. To this end, the irradiation lamp is preferably surrounded by a quenching space which comprises an IR quenching liquid and is preferably arranged between the irradiation lamp and the sample container, particularly preferably between the inert gas flushing and the sample container.

IR quenching liquids particularly suitable for the purposes of the present invention comprise all liquids which are fluid under the study conditions and at least partially absorb light in the range of from 780 nm to 1 mm.

The use of an IR filter substantially avoids heating of the granules during the irradiation.

Likewise, the shape of the sample container is not subject to any particular limitations. Nevertheless, sample containers with a region which comprises a straight cylindrical shape have proven suitable, the irradiation lamp preferably being arranged centred in the middle of the cylinder.

In the scope of a particularly preferred embodiment of the present invention, the irradiation lamp has an elongate shape, the alignment of the irradiation lamp preferably corresponding to the principal axis of the sample container, in particular the principal axis of the straight cylindrical part of the sample container.

The inner wall of the sample container preferably comprises a reflective material in order to direct the light, which has for example not struck the granules or has travelled past them, after reflection onto the granules. The effectiveness of the irradiation can be increased significantly in this way. In this context, particularly suitable reflective materials lead to reflection of at least 5%, preferably at least 25%, particularly preferably at least 50% of the incident radiation. Steel is a material which is particularly suitable for this purpose.

Preferably, at least 80% of the total inner surface of the sample container is coated with the reflective material and/or consists of it.

In the scope of a particularly preferred embodiment of the present invention, the sample container furthermore comprises a material having a high thermal conductivity, preferably a thermal conductivity of more than 1 W/(m·K), in particular more than 3 W/(m·K), measured at 25° C.

Preferably, at least 80% of the sample container consists of a material having a high thermal conductivity.

The device of the present invention preferably also comprises at least one temperature control element, preferably a heating or cooling element, in particular a cooling element, which makes it possible to irradiate the plastic particles under fixed predetermined temperature conditions or in fixed predetermined temperature ranges.

The sample container furthermore preferably comprises a mixing element for mixing the granules during the irradiation. Flow baffles, which partially deviate the movement of the granules during rotation of the container along its principal axis, have proven particularly suitable in this context.

In order to increase the effect of blending the granules, the head and/or foot end, particularly preferably the head and foot ends, of the sample container are preferably canted so as to blend granules even more strongly during the irradiation. In this case, the inner diameter of the sample container preferably decreases in the direction of the canted end.

The size of the sample container is of secondary importance. The sample container is preferably dimensioned so that it can hold between 10 g and 500 kg of granules. Sample containers which are more particularly suitable for the purposes of the present invention have a holding capacity in the range of from 1 kg to 10 kg.

During the irradiation, the sample container is preferably filled with granules to from 0.1% to 10%, preferably to from 0.5% to 5%, expressed in terms of the total volume of the sample container.

In the scope of the present invention, the sample container is preferably rotated in order to achieve blending of the granules. The rotation is preferably carried out about a principal axis of the container, the irradiation lamp preferably also being positioned along its principal axis.

The rotation speed is preferably in the range of from 1 rpm to 500 rpm.

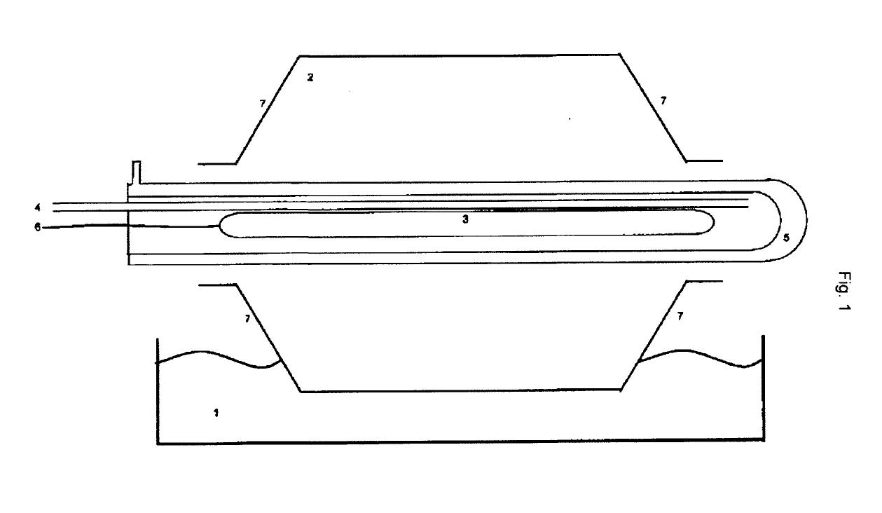

The structure of an irradiation apparatus which is particularly suitable for the purposes of the present invention is shown schematically in FIG. 1. It comprises an irradiation lamp (3) and a sample container (2), the irradiation lamp (3) having an elongate design and being arranged centred along the principal axis of the sample container (2).

The sample container (2) has a straight cylindrical shape with canted head and foot ends (7), the inner diameter of the sample container (2) decreasing in the direction of the canted ends (7).

The sample container (2) is preferably made of a thermally conductive steel, which reflects at least 5% of the incident radiation.

The irradiation lamp is surrounded by inert gas flushing (4), which is arranged between the irradiation lamp (3) and the sample container (2).

The irradiation lamp (3) is furthermore surrounded by a quenching space (5), which comprises an IR quenching liquid and is arranged between the inert gas flushing (4) and the sample container (2).

The device comprises a temperature control element (1), preferably a cooling water bath, for thermally regulating the sample container (2) in the course of the irradiation.

During the irradiation, the sample container (2) is rotated preferably continuously about the principal axis of the sample container (3), along which the irradiation lamp (3) is positioned.

The temperature during the irradiation may in principle be selected freely, and in particular matched to the conditions which are intended to be simulated or reproduced. For the purposes of the present invention, however, the temperature preferably lies in the range of from 0° C. to 95° C.

The intensity of the irradiation of the granules can be controlled via the duration of the irradiation and the irradiation strength. The irradiation is preferably carried out for each time in the range of from 1 h to 1000 h, particularly in the range of from 24 h to 500 h. The irradiation of the granules is furthermore preferably carried out with an irradiation strength in the UV-B band in the range of from 1 W/m² to 10,000 W/m², particularly in the range of from 100 W/m² to 1000 W/m².

In the scope of a particularly preferred variant of the rapid test according to the invention, the colour properties of the granules are furthermore studied before and after the irradiation. The colour measurement is preferably carried out in accordance with DIN 5033.

Furthermore, the zinc elution of the granules is preferably studied before and after the irradiation. The measurement of the zinc elution is preferably carried out in accordance with the prestandard DIN V 18035-7, 6.11.3 (Sports Grounds, Part 7: Synthetic Turf Areas). In particular, the following procedure has proven suitable:

In order to determine the concentration of heavy metals, 100 g of granules in a flask with a CO₂ feed instrument are eluted with 1 l of deionized water (granule to water as 1:10) with a constant delivery of CO₂ gas (about 50 ml of CO₂/min) for 24 h. The eluate is filtered off through a glass filter (acid wash, 0.3 μm to 1 μm) (1^{st} eluate). The same sample is then subjected to a second elution for 24 h (2^{nd} elution: 24 h to 48 h, so-called acid 48 h eluate), and the eluate is filtered off. In order to dislodge the adhering gas bubbles, the flask is shaken occasionally during the elution (optionally with a vibrating table).

The heavy metal concentrations determined in the acid 48 h eluate are preferably used for the evaluation.

In the scope of a particularly preferred variant of the rapid test according to the invention, the water retention capacity of the granule is furthermore studied before the irradiation. It is furthermore particularly preferable to determine the water retention capacity of the granule after the irradiation.

In order to determine the water retention capacity, the following procedure has proven particularly suitable in this context:

In a plastic cylinder (Dᵢₙₙₑᵣ=27 mm, H=160 mm) whose lower side is provided with a gauze fabric (mesh width about 0.4 mm), an approximately 40 mm high bed of the sample is introduced. The cylinder is fitted on a balance and immersed into a water container in order to cover the granule bed with a liquid (about 10 mm clearance). In order to wet the sample with fully deionized water, the sample and water are stirred after the 1^{st} immersion.

The granules may possibly be difficult to wet with water. In such a case, the air bubbles cannot be fully removed after filling with water.

After removing the water container, the mass change of the cylinder with the sample is recorded (measurement interval 1 s). In each case, 2 beds are measured 2 times. The measurement values of a dummy test (empty cylinder) are subtracted from the recorded measurement values, and the result is expressed in terms of the dry sample mass (mass of the wet sample divided by the mass of the dry sample).

The described test for determining the water retention capacity can be carried out rapidly and requires only little sample material. The purpose of the study with this test is to evaluate how much water is retained by a particle bed after a short draining phase.

In particular, the response of synthetic turf with filler material to heavy rain is very important for the application. If a synthetic turf system allows rainwater to flow away very rapidly, then for example even strong rain interferes little or not at all with football matches, compared with a synthetic turf system which does not allow water to drain very rapidly.

Because the filler material bed has a great effect on this, the test developed for the water drainage behaviour allows very rapid and simple assessment or ranking of different filler materials in respect of their water drainage behaviour and therefore the playability in rainy weather.

Coated rubber particles having the following properties have proven more particularly suitable as filler materials for synthetic turf:
abrasion before irradiation: at most 2%
abrasion after irradiation: at most 2.5%
colour change after irradiation: ΔE*ab at most 4
zinc elution before irradiation: at most 3 mg/l
zinc elution after irradiation: at most 3 mg/l
water retention capacity before irradiation: at most 60%.

These values refer to measurements according to the methods described in the experimental part.

The invention will be further illustrated below by several examples, without thereby intending to restrict the concept of the invention.

### EXAMPLES

A device with a schematic structure according to FIG. 1 was used for the irradiation. In a cylindrical VA drum reactor with a capacity of about 12 litres (length: 19.6 cm; diameter: 27.4 cm; irradiated area: 1687 cm²) with a flow baffles and water cooling, a borosilicate glass tube with water cooling and nitrogen flushing was positioned on the rotation axis and an iron-doped Hg medium-pressure radiator with a luminous length of 150 mm and a maximum power of 1.8 kW, which could be operated by a suitable electronic ballast, was positioned in the borosilicate glass.

In a glass beaker, 100 g of the coated or uncoated sample to be irradiated were weighed out and introduced into the reactor. The immersion tube with the UV radiator was then installed in the holder provided for this purpose. The nitrogen flow rate was set at 6 l/h, and the cooling water flow rate at 100 l/h. The UV exposure apparatus was then turned on, and the motor which provided the reactor rotation (12 rpm) was started.

The coated or uncoated sample to be studied was then irradiated for 240 hours with a 1.55 kW radiator power (wavelength of the radiation to which the sample was exposed in the UV range: 295-380 nm) under rotation.

After the irradiation had been completed, the apparatus was turned off and the irradiated coated or uncoated sample was removed quantitatively from the reactor.

The sample was subjected to the following tests, in order to study the effect of the UV irradiation.

In its intensity in the UVB range, the described UV test was approximately 360 times stronger than natural sunlight in summer at noon in Germany through 24 hour continuous irradiation. A radiator power of 1.55 kW gave the following powers for the UVA and UVB ranges:
UVB (295-315 nm)=74 W
UVA (315-380 nm)=325 W;

The drum dimensions provided an irradiated area of 1687 cm², which means an irradiation strength of 439 W/m² for the UVB range.

In order to obtain the results, the following procedure was adopted:

First the colour, the abrasion and the zinc elution of the unirradiated product were measured. Next, a specimen of a product was respectively subjected to the UV irradiation in the UV irradiation apparatus, the irradiated product was removed as quantitatively as possible from the apparatus and in each case subjected to a further test or all the tests: either zinc elution or colour measurement or abrasion or water retention capacity, or all the tests indicated.

The difference [values of the study after UV irradiation] minus [values of the study before UV irradiation] gives a Delta value whose magnitude and sign described the effect of the UV irradiation on the material tested.

### UV-Elutable Substances, for Example Zn

| | untreated | | |
|---|---|---|---|
| | specimen | after UV | |
| Designation | zinc (mg/L) | zinc (mg/L) | Δ_{Zn (mg/L)} |
| GTR | 5.0 | 5.4 | 0.4 |
| Granufill | 3.6 | 5.4 | 1.8 |
| (CGTR) | | | |
| Evonik 1 | 0.3 | 1.3 | 1.0 |
| Evonik 2 | 0.8 | 2.6 | 1.8 |
| Evonik 3 | 0.5 | 2.4 | 1.9 |

GTR: ground tyre rubber, rubber granule

The zinc content was determined according to the prestandard DIN V 18035-7, 6.11.3 (Sports Grounds, Part 7: Synthetic Turf Areas).

### UV Abrasion

| | untreated | after UV | |
|---|---|---|---|
| | specimen | abrasion | |
| Designation | abrasion (%) | (%) | Δ_{abrasion} |
| RTW GO 2008 | 6.0 | 7.37 | 1.37 |
| RAL 6025 | | | |
| (CGTR) | | | |
| Granufill (CGTR) | 2.84 | 2.51 | −0.33 |
| GTR | 1.25 | 1.6 | 0.35 |
| Evonik 1 | 1.50 | 1.80 | 0.30 |
| Evonik 2 | 1.40 | 1.90 | 0.50 |
| Evonik 3 | 1.10 | 2.50 | 1.40 |

CGTR: coated GTR

### UV Colour

| | untreated specimen | | | after UV | | | |
|---|---|---|---|---|---|---|---|
| Designation | L | a | b | L | A | b | ΔE*ab |
| MRH green | 18.95 | −8.68 | 8.07 | 14.81 | −6.01 | 8.24 | 4.93 |
| SOCC (CGTR) | | | | | | | |
| RTW GO 2008 | 29.90 | −7.88 | 14.18 | 22.19 | −4.36 | 8.78 | 10.06 |
| RAL 6025 | | | | | | | |
| (CGTR) | | | | | | | |
| Granufill | 18.20 | −12.79 | 9.80 | 15.74 | −7.54 | 7.37 | 6.29 |
| (CGTR) | | | | | | | |
| Evonik 1 | 36.96 | −5.31 | 2.25 | 36.00 | −3.66 | 2.03 | 1.92 |
| Evonik 2 | 40.88 | −7.22 | 6.70 | 39.42 | −5.40 | 5.82 | 2.49 |
| Evonik 3 | 38.26 | −6.08 | 3.55 | 36.26 | −3.48 | 2.59 | 3.42 |

The colour measurement was determined in accordance with DIN 5033.

### Water Retention Capacity Before Irradiation

| | Moisture | |
|---|---|---|
| | after 30 s | |
| Designation | [%] | STDEV [%] |
| “GTR Fine” from GENAN | 58 | 4 |
| Evonik W1 | 36 | 2 |
| Evonik W2 | 43 | 1 |
| GO 2008 RAL 6025 | 110 | 6 |
| Granufill from Granuband | 92 | 1 |
| Foamed EPDM, from Melos | 71 | 2 |

The water retention capacity was ascertained according to the test described above.

1. A method of ascertaining an effect of irradiation on an abrasion of a granule, the method comprising:
i.) determining an abrasion of the granule before irradiation;
ii.) irradiating the granule to obtain an irradiated granule;
iii.) determining the abrasion of the irradiated granule, wherein
the determining i.) comprises:
a) grinding the granule in a cutting mill to obtain a ground product;
b) subjecting the ground product to a screening analysis; and
c) comparing a result of the screening analysis with at least one reference value, in order to classify the abrasion of the granule, and
wherein the irradiating ii.) comprises:
arranging a plurality of granule particles in a sample container and irradiating the plurality of granule particles with an irradiation lamp, the granule particles being periodically blended during the irradiating so that different surfaces of the granule particles are irradiated.

2. The method of claim 1, further comprising:
studying color properties of the granule before and after the irradiation.

3. The method of claim 1, further comprising:
studying zinc elution of the granule before and after the irradiation.

4. The method of claim 1, further comprising:
studying water retention capacity of the granule before the irradiation.

5. The method of claim 1, further comprising:
studying water retention capacity of the granule after the irradiation.

6. The method of claim 1, wherein a particle size distribution of the ground product is ascertained by discontinuous screening.

7. The method of claim 1, wherein a fraction of particles smaller than 500 μm is selected as a criterion according to which the abrasion of the particles is assessed.

8. The method of claim 1, wherein at least two different surfaces of the granule are irradiated successively, each of these surfaces being irradiated at least twice.

9. The method of claim 1, wherein the granule is irradiated with light having a wavelength in a range of from 1 nm to 1000 nm.

10. The method of claim 1, wherein the granule is irradiated with a device which comprises:
a. at least one irradiation lamp; and
b. at least one sample container for the granule to be irradiated,
wherein the sample container is connected to a drive so that the sample container can be moved during the irradiation and the granules can be blended.

11. The method of claim 10, wherein the sample container is rotated periodically with a speed in a range of from 1 rpm to 500 rpm.

12. The method of claim 10, wherein the irradiating ii.) is carried out at a temperature in a range of from 0° C. to 95° C.

13. The method of claim 1, wherein the irradiating ii.) is carried out for a time in a range of from 1 h to 1000 h.

14. The method of claim 1, wherein the irradiating ii.) is carried out with light having an irradiation strength in a range of from 1 W/m² to 10,000 W/m².

15. The method of claim 1, further comprising:
determining a strength and bonding of at least one material layer on a surface of the granule or in interlayers of multilayered granules before and/or after the irradiating ii.).

16. The method of claim 1, wherein at least one coated rubber particle is studied.

17. The method of claim 1, wherein at least one particle obtained from a material composite is studied.

18. A coated rubber particle, having the following properties:
an abrasion before irradiation of at most 2%;
an abrasion after irradiation of at most 2.5%;
a color change after irradiation, ΔE*ab of at most 4;
a zinc elution before irradiation of at most 3 mg/l;
a zinc elution after irradiation of at most 3 mg/l; and
a water retention capacity before irradiation of at most 60%.

19. The method of claim 2, further comprising:
studying zinc elution of the granule before and after the irradiation.

20. The method of claim 2, further comprising:
studying water retention capacity of the granule before the irradiation.
